(19) United States
(12) Patent Application Publication
(10) Pub. No.: US 2003/0062825 A1
(43) Pub. Date: Apr. 3, 2003

(54) Electric luminescent element

(76) Inventor: Chih-Yuan Wang, Taichung Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/964,557

(22) Filed: Sep. 28, 2001

(51) Int. Cl. H05B 33/14

(52) U.S. Cl. 313/503

(57) ABSTRACT

An electric luminescent element is disclosed. The conventional structure in the electric luminescent element is improved. A luminous layer which can absorb and store energy is mixed in the electric luminescent element. By special luminous material, the luminous layer is mixed or combined with one of the layers. By the principle of the light absorption and emission of the luminous layer, the power can be saved. Thereby, the electric luminescent element may emit power in dark place without any driving power.

### FIELD OF THE INVENTION

The present invention relates to an electric luminescent element, wherein a luminous layer which can absorb and store energy is mixed in the electric luminescent element. By a special luminous material, the luminous layer is mixed or combined with one of the layers. Therefore, the electric luminescent element can emit light in dark place

### BACKGROUND OF THE INVENTION

In general, inorganic electric luminescent elements like thin pieces and are primarily used as a back light element to be used in for example, PDAs, handsets, etc. Referring to FIG. 8, a prior art electric luminescent element is illustrated. The electric luminescent element is formed sequentially by a transparent substrate layer 71, a front electrode layer 72, a light emitting layer 73, an electric inducing layer 74, a back electrode layer 75 and an insulating packaging layer 76. An AC voltage is applied to the front electrode layer 72 and the back electrode layer 75. The light emitting layer 73 of the electric luminescent element may emit light.

Since in market, the electric luminescent element is used as a back light. As it is used as a back light of PDAs, handsets, etc., due to the confinement of the pigments, in general, only green light, indigo light, deep blue light, orange light, and white light. The original and white light are seldom used and have a short lifetime. Furthermore, no red light presents. Therefore, commercially, fluorescent materials are mixed into the luminous powders. For example, white electric luminescent element is formed by mixing indigo light with pink pigment or dye. The yellow green electric luminescent element is formed by green luminous powders with yellow pigment or dye.

However, these fluorescent pigments or dyes will stop to emit light as light disappears. No light is emitted. Therefore, this prior design is not practical.

### SUMMARY OF THE INVENTION

Accordingly, the primary object of the present invention is to provide an electric luminescent element, wherein a luminous layer which can absorb and store energy is mixed in the electric luminescent element. By special luminous material, the luminous layer is mixed or combined with one of the layers. By the principle of the light absorption and emission of the luminous layer, the power can be saved.

Another object of the present invention is to provide an electric luminescent element, wherein it may be made as background of various colors in the dark place

Another object of the present invention is to provide an electric luminescent element, wherein the luminous powders and electric luminescent element are combined so that light is emitted as a driving power is applied; while as the driving power disappears, the luminous powders will emit light and moreover, they also absorb light so that the present invention has the effect of environmental protection.

The various objects and advantages of the present invention will be more readily understood from the following detailed description when read in conjunction with the appended drawing.

### BRIEF DESCRIPTION OF THE DRAWINGS

FIG. 1 is a schematic cross sectional view of the first embodiment in the present invention.

FIGS. 2A and 2B are schematic view showing the operation of the luminous layer which absorbs and releases light according to the present invention.

FIG. 3 is a schematic cross sectional view of second embodiment in the present invention.

FIG. 4 is a schematic cross sectional view of third embodiment in the present invention.

FIG. 5 is a schematic cross sectional view of fourth embodiment in the present invention.

FIG. 6 is a schematic cross sectional view of fifth embodiment in the present invention.

FIG. 7 is a schematic cross sectional view of sixth embodiment in the present invention.

FIG. 8 is an assembled schematic cross sectional view of a prior art design.

### DETAILED DESCRIPTION OF THE PREFERRED EMBODIMENTS

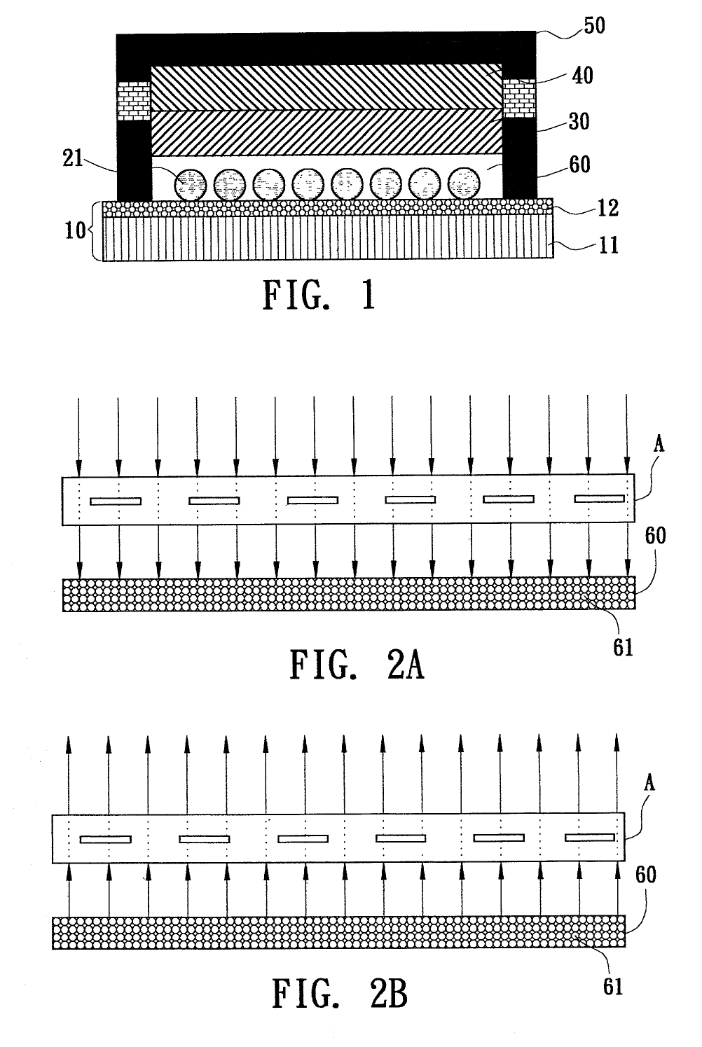

Referring to FIG. 1, an electric luminescent element of the present invention is illustrated. The electric luminescent element has a front electrode layer 10. A lighting emitting layer 20 with a plurality of luminous powders 61 is over the front electrode layer 10. An electric inducing layer 30 is formed on the light emitting layer 20. A back electrode layer 40 is formed on the electric inducing layer 30. The outer periphery of the back electrode layer 40 is packaged by an insulating packaging layer 50. A luminous layer 60 with a plurality of luminous powders 61 is mixed or combined with one of the layers.

In this embodiment, the front electrode layer 10 is formed by a transparent substrate 11 and a conduction layer 12. The insulating packaging layer 50 in this embodiment is an insulating layer and an ACP layer (not shown).

Referring to FIG. 2, the electric luminescent element of the present invention may be installed on a liquid crystal screen A, handset screen or PDA screen, etc. By the alternative current driving of the front electrode layer 10 and the back electrode layer 40, when the light emitting layer 20 emits light, the light emitting particles 31 will be excited so as to cause the light emitting layer 20 to emit light.

Since light may transmit through an object. When in the daytime or as it is radiated by lamps, the luminous powders 61 in the luminous layer 60 of the electric luminescent element will absorb light continuously and stores energy in the luminous layer 60. When at night or in dark place, the luminous powders 61 in the luminous layer 60 will release light continuously for providing light. Therefore, it has the effect of environmental protection.

In the present invention, during the manufacturing process of the electric luminescent element, by special luminous material, the luminous layer 60 is mixed or combined with one of the layers. By the principle of the light absorption and emission of the luminous layer 60, the power can be saved.

In the present invention, the luminous powders and electric luminescent element are combined so that light is emitted as a driving power is applied. While as the driving power disappears, the luminous powders will emit light and moreover, they also absorb light. The present invention is used in the dark, but it can be used with other fluorescent materials. For example, an electric luminescent element emitting white light is formed by mixing indigo luminous powders with the pink pigment. The yellow green electric luminescent element is formed by green luminous powders with yellow pigment. They may be made as background of various colors in the dark place.

Other embodiment may achieve the same effects. Referring to FIG. 3, the second embodiment of the present invention is illustrated. The luminous layer 60 is directly installed in the transparent substrate 11. The plurality of luminous powders 61 in the luminous layer 60 can absorb light from the daylight or lamp and then store the energy in the luminous layer 60. When at night or in the dark, the plurality of luminous powders 61 in the luminous layer 60 may release energy continuously so as to provide visible light so as to have effect of environmental protection.

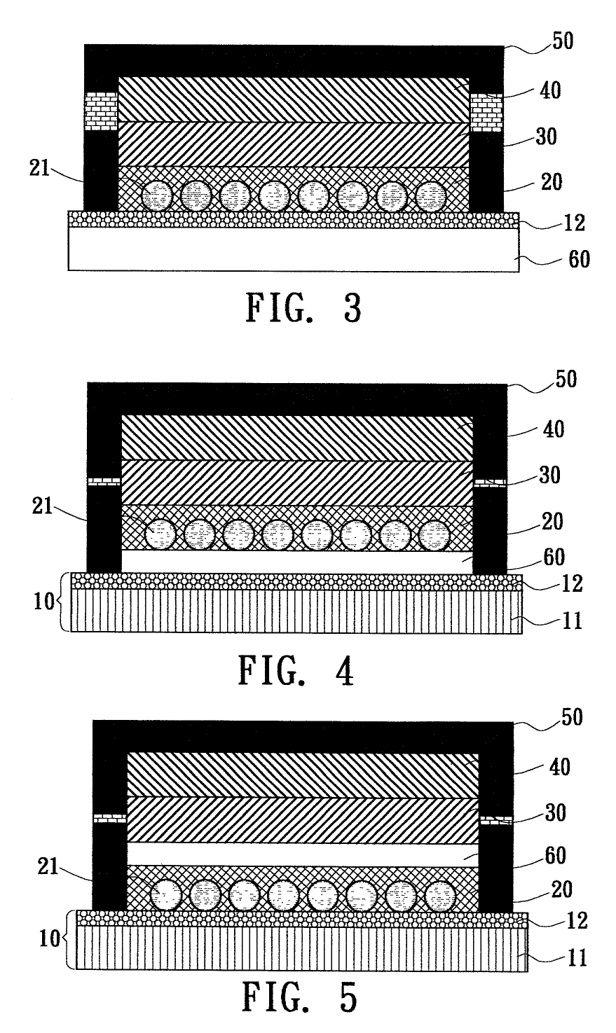

Referring to FIG. 4, the third embodiment of the present invention is illustrated. The luminous layer 60 is disposed between the front electrode layer 10 and the light emitting layer 20. The plurality of luminous powders 61 in the luminous layer 60 can absorb light from the daylight or lamp and then store the energy in the luminous layer 60. When at night or in the dark, the plurality of luminous powders 61 in the luminous layer 60 may release energy continuously so as to provide visible light and thus have effect of environmental protection.

Referring to FIG. 5, the fourth embodiment of the present invention is illustrated. The luminous layer 60 is disposed between the light emitting layer 20 and the electric inducing layer 30. The plurality of luminous powders 61 in the luminous layer 60 can absorb light from the daylight or lamp and then store the energy in the luminous layer 60. When at night or in the dark, the plurality of luminous powders 61 in the luminous layer 60 may release energy continuously so as to provide visible light and thus it has an effect of environmental protection.

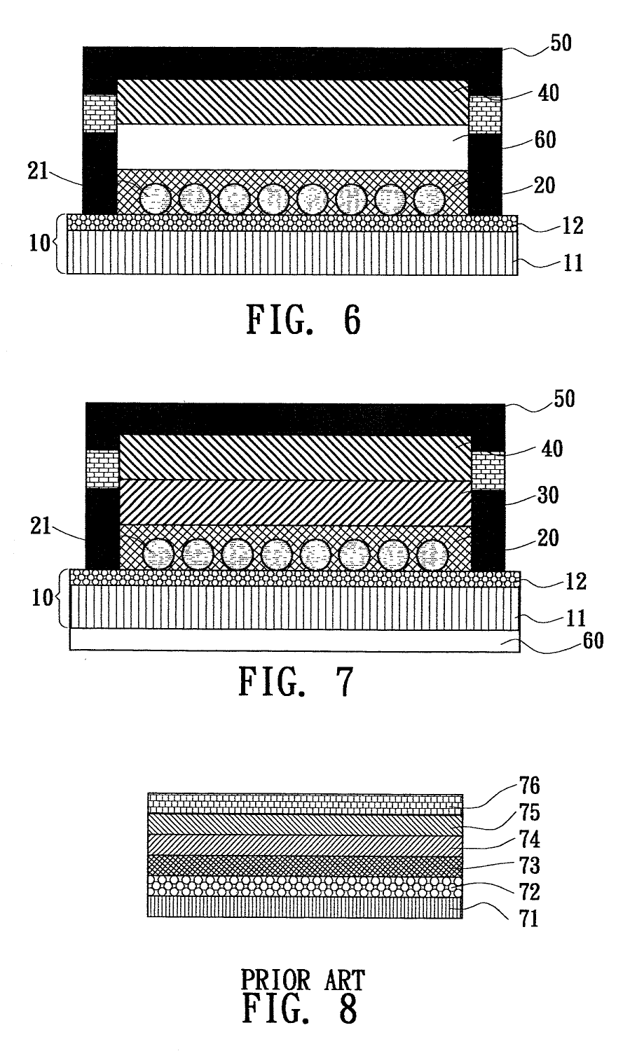

Referring to FIG. 6, the fifth embodiment of the present invention is illustrated. The luminous layer 60 is disposed in the electric inducing layer 30. The plurality of luminous powders 61 in the luminous layer 60 can absorb light from the daylight or lamp and then store the energy in the luminous layer 60. When at night or in the dark, the plurality of luminous powders 61 in the luminous layer 60 may release energy continuously so as to provide visible light and thus it has an effect of environmental protection.

Referring to FIG. 7, the sixth embodiment of the present invention is illustrated. The luminous layer 60 is disposed in front of the transparent substrate. The plurality of luminous powders 61 in the luminous layer 60 can absorb light from the daylight or lamp and then store the energy in the luminous layer 60. When at night or in the dark, the plurality of luminous powders 61 in the luminous layer 60 may release energy continuously so as to provide visible light and thus it has an effect of environmental protection.

Therefore, the above said electric luminescent element has the advantage of saving power. The luminous layer may absorb light and release light so that light energy can be saved.

The present invention are thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. An electric luminescent element having an inorganic electric luminescent element with a front electrode layer; a lighting emitting layer with a plurality of luminous powders being over the front electrode layer; an electric inducing layer being formed on the light emitting layer; a back electrode layer being formed on the electric inducing layer; an outer periphery of the back electrode layer being packaged by an insulating packaging layer; a luminous layer with a plurality of luminous powders being mixed or combined with one of the layers;
wherein by the alternative current driving of the front electrode layer and the back electrode layer, when the light emitting layer emits light, the light emitting particles will be excited so as to cause the light emitting layer to emit light.

2. The electric luminescent element as claimed in claim 1, wherein the luminous layer is in the light emitting layer.

3. The electric luminescent element as claimed in claim 1, wherein the front electrode layer is formed by a transparent substrate and a conduction layer.

4. The electric luminescent element as claimed in claim 3, wherein the luminous layer is in the transparent substrate.

5. The electric luminescent element as claimed in claim 1, wherein the luminous layer is disposed between the front electrode layer and the light emitting layer.

6. The electric luminescent element as claimed in claim 1, wherein the luminous layer is disposed between the light emitting layer and the electric inducing layer.

7. The electric luminescent element as claimed in claim 1, wherein the luminous layer is directly disposed in the electric inducing layer.

8. The electric luminescent element as claimed in claim 1, wherein the luminous layer is directly disposed in front of the transparent substrate.
